(19) United States
(12) Patent Application Publication
(10) Pub. No.: US 2011/0190034 A1
(43) Pub. Date: Aug. 4, 2011

(54) MOBILE TERMINAL AND METHOD FOR DISPLAYING INFORMATION

(75) Inventor: Dong Chan SHIN, Seoul (KR)

(73) Assignee: PANTECH CO., LTD., Seoul (KR)

(21) Appl. No.: 13/006,118

(22) Filed: Jan. 13, 2011

(30) Foreign Application Priority Data
Jan. 29, 2010 (KR) 10-2010-0008825

(51) Int. Cl. H04W 88/02; G06F 3/041

(52) U.S. Cl. 455/566

(57) ABSTRACT

Disclosed herein are a mobile terminal and a method for displaying information using the same. A mobile terminal includes a display unit that displays information or applications processed in the mobile terminal on a display panel; and a control unit that controls the information or applications displayed on the display unit to be rotated at an angle with respect to the display panel and controls additional information or applications to be displayed on portions about the displayed information or applications produced by the rotation if a reference signal is inputted to the mobile terminal.

### CROSS-REFERENCE TO RELATED APPLICATION

This application claims priority from and the benefit under 35 U.S.C. §119(a) of Korean Patent Application No. 10-2010-0008825, filed on Jan. 29, 2010, which is hereby incorporated by reference for all purposes as if fully set forth herein.

### BACKGROUND

1. Field

The following description relates to a mobile terminal and a method for displaying information using the same.

2. Discussion of the Background

As telecommunication technologies and infrastructures have been rapidly improved, mobile terminals have been developed as to provide not only general voice is communications but also various services such as game, message transmission/reception, Internet search, wireless data communication, electronic note, digital camera, and video telephony services.

Recently, as users' requests for services are increased and the services are highly functionalized, attempts have been made to enhance users' convenience by introducing features, such as a graphic user interface (GUI) similar to a personal computer (PC) or a touch panel in a mobile terminal.

A mobile terminal having a touch panel generally provides a user interface device using a touch method in place of a keypad typically used as an input of a display panel. The touch panel generally generates a voltage or current signal at a position on a touch pad that is touched by an input device, such as a touch pen, finger, or the like, to input an instruction specified by a user to the touch panel. Such a touch panel enables a user to input desired information through a naturally used input device.

### SUMMARY

Exemplary embodiments of the present invention provide a mobile terminal and a method for displaying information using the same, in which additional information is displayed on a blank screen produced by rotating a current window of the mobile terminal.

Additional features of the invention will be set forth in the description which follows, and in part will be apparent from the description, or may be learned by practice of the invention.

An exemplary embodiment provides a mobile terminal including: a display unit comprising a display panel to display first information processed in the mobile terminal; and a control unit to control the first information displayed on the display unit, and, if a reference signal is received to the mobile terminal, to rotate a first window of the first information to an angle with respect to the display panel and to display second information in at least a first portion of the display panel between an edge of the first window and an edge of the display panel, the first portion being produced by a rotation of the first window.

An exemplary embodiment provides a method for displaying information using a mobile terminal, the method including: displaying information processed in the mobile terminal on a display panel of the mobile terminal; receiving a reference signal to the mobile terminal; and rotating the displayed information to an angle and displaying additional information in a first portion of the display panel produced by the rotation if the reference signal is received to the mobile terminal.

An exemplary embodiment provides a method for displaying information using a mobile terminal, the method including: displaying a first window of first information processed in the mobile terminal on a display panel of the mobile terminal; receiving a reference signal to the mobile terminal; and rotating the first window at an angle with respect to the display panel and displaying second information in a first portion of the display panel between an edge of the rotated first window and an edge of the display panel produced by the rotation if the reference signal is received to the mobile terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a view of a mobile terminal according to an exemplary embodiment.

FIGS. 2A and 2B show a first window rotated and displayed in the mobile terminal of FIG. 1.

FIG. 3 shows information displayed based on the rotation direction of the mobile terminal of FIG. 1.

FIGS. 4A and 4B show a window controlled based on the rotation of a mobile terminal according to an exemplary embodiment.

FIGS. 5A, 5B and 5C show additional information are displayed in portions about a rotated window on a display panel in a mobile terminal according to exemplary embodiments.

FIG. 6 is a flowchart illustrating a method for displaying information using the mobile terminal of FIG. 1.

### DETAILED DESCRIPTION OF THE ILLUSTRATED EMBODIMENTS

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises”, “comprising”, “includes”, and/or “including”, when used in this specification, specify the presence of stated features, regions, integers, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

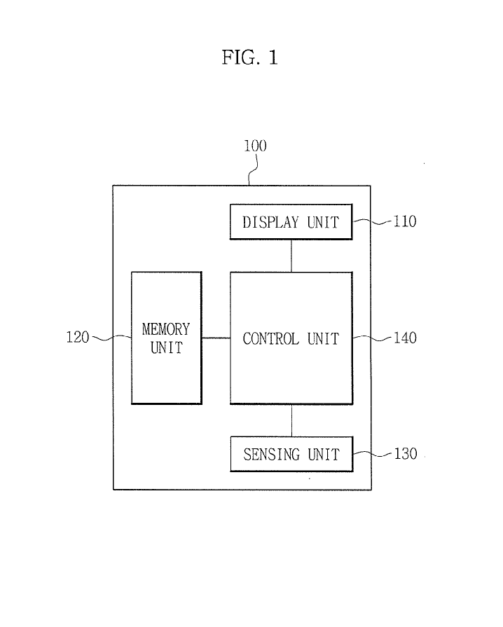

FIG. 1 is a view of a mobile terminal according to an exemplary embodiment. Referring to FIG. 1, the mobile terminal 100 includes a display unit 110, a memory unit 120, a sensing unit 130, and a control unit 140.

The display unit 110 includes a user interface and a graphical user interface according to information processed in the mobile terminal 100. The display unit 100 may include a display panel (not shown), and the display panel may be at least one of a liquid crystal display (LCD), a thin film transistor-liquid crystal display (TFT-LCD), an organic light-emitting diode (OLED) display, a plasma display panel (PDP) a flexible display, a three-dimensional (3D) display, and the like.

The display panel of the display unit 110 may include a touch panel or the display unit 110 may include a touch panel in addition to the display panel. The touch panel may receive an external signal inputted by converting a change in pressure applied to a surface of a touch panel or a change in capacitance generated at a specific portion of the touch panel into an electrical input signal. The touch sensor may be in the form of a touch film, a touch sheet, a touch pad, or the like. The touch sensor may sense not only a touched position and area but also pressure at the time of touch and movement of the touch after the touch. The signal sensed by the touch sensor is transmitted to a touch controller, and the sensed signal processed by the touch controller is transmitted to the control unit 140.

The display unit 110 may display first information on the display panel in a first window and may display second or additional information in portions about the first window, which will be described below. Further, the display unit 110 may display the first information and an application processed in the mobile terminal 100 in the first window on the display panel and may display the second information and an application in the portions about the first window on the display panel. Moreover, the display unit 110 may display a first application in the first window on the display panel and a second application in the portions about the first application in the first window. Although described as first and second, the display unit 110 may information and/or applications in more or fewer windows and/or portions on the display panel.

The memory unit 120 may store program or data for control in the mobile terminal 100 or data inputted to or outputted from the mobile terminal 100. If a reference signal is inputted to the mobile terminal 100, the memory unit 120 may recognize a first window outputted to the display unit 110 as a current first window and store the recognized first window. The current first window refers to a first window displayed on the display panel at the time when a reference signal is inputted. The memory unit 120 may include at least one type of storage medium, including at least one of a flash memory type, a hard disk type, a multimedia card micro type, a card type memory, a random access memory (RAM), a static random access memory (SRAM), a read-only memory (ROM), an electrically erasable read-only memory (EEPROM), a programmable read-only memory (PROM), a magnetic memory, a magnetic disk, or an optical disk.

The sensing unit 130 senses the rotation and/or movement of the mobile terminal 100 through a motion detection sensor and generates a motion detection signal based on a rotational direction, a rotational angle, a position, and/or a movement of the mobile terminal 100 according to the rotation, and the like. Specifically, the sensing unit 130 generates the motion detection signal based on a position of the mobile terminal 100, a rotational direction, a rotational angle, and the like. The mobile terminal 100 may have a rectangular shape and may be positioned in various positions, for example, with a length in the vertical direction or a width in the vertical direction. The position of the mobile terminal 100 describes how the mobile terminal 100 is positioned with reference to gravity. The rotational direction of the mobile terminal 100 may include a left direction, a right direction, an upward direction, a downward direction, and the like about a reference axis. The rotational angle of the mobile terminal 100 is an angle at which the mobile terminal 100 is rotated about the reference axis. Accordingly, the sensor of the sensing unit 130 may sense a rotational angle or intervals a rotational angle.

The control unit 140 generally controls the operations required in the mobile terminal 100. For example, the control unit 140 may perform control and processes related to voice telephony, data communication, video conference, and the like. If a reference signal is inputted, the control unit 140 rotates the first window displayed on the display unit 110 and displays additional information or an application in portions about the first window produced by the rotation or movement of the mobile terminal 100. The portions about the first window produced by the rotation or movement of the mobile terminal are a residual space or spaces between an edge or edges of the display panel of the display unit 110 and the first window rotated or moved according to the reference signal. The reference signal is a signal set so that the current first window is rotated. The reference signal may be a user input signal inputted to the mobile terminal 100, and may include an operational signal received through buttons, a drag or touch signal received through the touch panel, a motion detection signal received through the rotation of the mobile terminal 100 by the sensing unit 130, and the like.

The control unit 140 may directly rotate the first window. Alternatively, the control unit 140 may store the first window displayed on the display unit 110 as a current first window in the memory unit 120 and then rotate the current first window.

The rotational angle of the first window may be predetermined. The rotational angle of the first window may be set as an arbitrary angle or an angle corresponding to the user input signal inputted to the mobile terminal 100. For example, if a reference signal for a rotation of 30 degrees is inputted to the mobile terminal 100, the control unit 140 may rotate the first window at 30 degrees. The control unit 140 may rotate the current first window based on the motion detection signal of the sensing unit 130. Specifically, if the sensing unit 130 generates a motion detection signal for the rotational direction and angle of the mobile terminal 100 and transmits the generated motion detection signal to the control unit 140, the control unit 140 rotates the first window by the rotational angle in the opposite direction to the rotational direction. The mobile terminal 100 may be continuously rotated, and the control unit 140 may control applications to be displayed in the portions about the first window depending on the rotational direction or angle of the mobile terminal 100. Thus, the control unit 140 can display various additional information and applications according to settings. If the mobile terminal 100 includes a touch panel, the control unit 140 may control the first window to be rotated based on a touch or drag signal and control information or applications to be displayed in the portions about the first window. Specifically, the control unit 140 may sense the direction and movement distance of the inputted drag signal and rotate the first window in the movement direction of the drag signal by the rotational angle corresponding to the movement distance of the drag signal.

If the first window is rotated, the control unit 140 may control a portion of the first window, which is not displayed on the screen of the mobile terminal 100 based on the rotation, to be omitted by maintaining the size of the first window, or may control the first window to be reduced and then rotated. For example the control unit 140 may control the first window to be reduced at a constant rate while being rotated and/or the control unit 140 may control the first window to be reduced in size so that each corner of the first window travels along respective edges of the display panel through the rotation of the mobile terminal 100.

The additional information or applications that the control unit 140 may display in the portions about the first window produced by the rotation of the mobile terminal 100 may include one or more of basic menu application information, detailed application information corresponding to the current first window and detailed information corresponding to the first window, and the like. For example, if the first window is a telephone or message transmitting/receiving application, the control unit 140 may control one or more of a reception number frequently used, a recent transmission number, and a reply application to be displayed in the portions about the first window. If the first window is a moving image, photograph, or scheduler application, the control unit 140 may control a detailed application function corresponding to the first window or detailed information on the information of the first window to be displayed in the portions about the first window. In addition, the control unit 140 may control application icons for a basic menu screen to be displayed in the portions about the first window, or may control shortcut icons capable of directly entering into a previously executed application to be displayed in the portions about the first window. The additional information or applications displayed in the portions about the first window according to various exemplary embodiments.

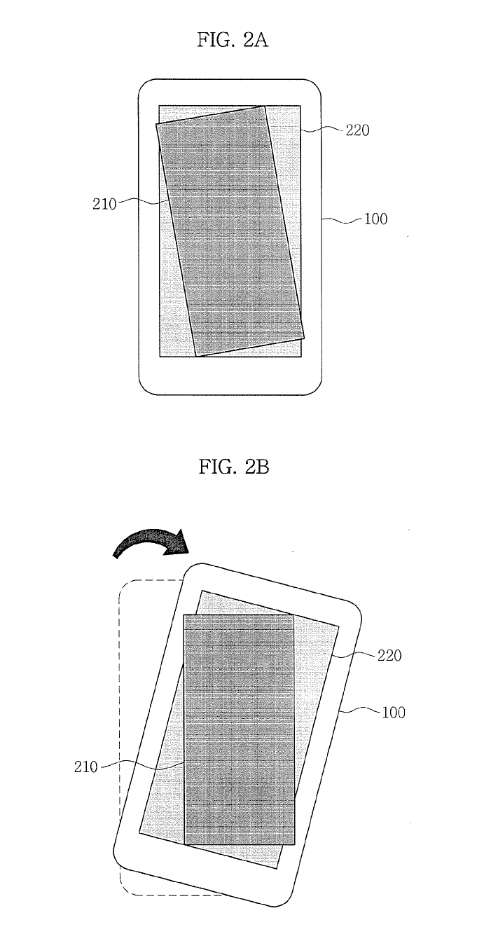

FIGS. 2A and 2B show a first window rotated and displayed in the mobile terminal of FIG. 1. FIG. 2A shows a first window rotated and displayed in the mobile terminal 100 while the mobile terminal 100 has a fixed position. FIG. 2B shows a first window rotated and displayed in the mobile terminal 100 while the mobile terminal 100 is rotated. Referring to FIG. 2A, if the position of the mobile terminal 100 is fixed, a first window 210 is rotated counterclockwise with respect to the mobile terminal 100 disposed in a vertical position. The first window 210 may be rotated by an input signal, touch signal, or drag signal. Additional information and applications may be further displayed in a second window 220 that is a portion disposed about the first window produced by the rotation in the display screen. The second window 220 may be disposed between an edge of the first window 210 and an edge of the display panel of the mobile terminal 100. When rotated, the first window may produce one or multiple second windows 220 disposed about the first window 210 disposed between the first window 210 and the edges of the display panel of the mobile terminal 100. Information and/or applications may be displayed in the second windows 220. The first window 210 may be a same or similar shape as a shape of the display panel of the mobile terminal, for example, a rectangle as shown in FIG. 2, such that if the rectangular representation of the first window 210 is rotated with respect to the rectangular display panel of the mobile terminal 100, triangular second windows 220 are generated due to the rotation of the first window 210 with respect to the display panel of the mobile terminal 100.

Referring to FIG. 2B, the position of the mobile terminal 100 is rotated, and the first window 210 is rotated according to a motion detection signal related to the rotational direction and angle of the mobile terminal 100. The first window 210 is rotated by retrogressing in the opposite direction to the rotational direction of the mobile terminal 100 by the rotational angle of the mobile terminal 100. That is, since the mobile terminal 100 of FIG. 2B is rotated clockwise at an angle, the first window 210 may be rotated counterclockwise at a same angle, and additional information and/or applications may be displayed on the second window 220 produced by the rotation. Again, the rotation of the first window 210 with respect to the mobile terminal 100 may produce one or more second windows 220 in which information and/or applications may be displayed. In addition to the rotation of the mobile terminal 100, a window displayed based on an operational input signal may be rotated.

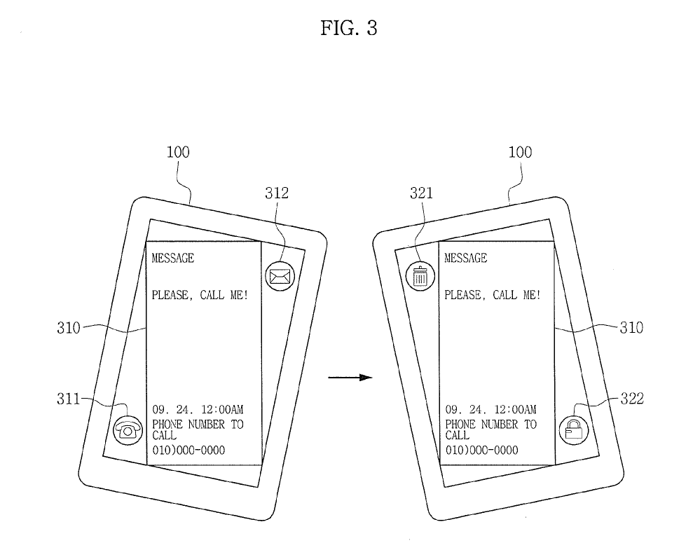

FIG. 3 shows information displayed based on the rotation direction of the mobile terminal 100 of FIG. 1. Referring to FIG. 3, if the mobile terminal 100 is rotated clockwise, a first window 310 retrogresses counterclockwise by the rotational angle of the mobile terminal 100. If the first window 310 retrogresses counterclockwise, a first icon 311 and a second icon 312 may be displayed in the portions about the first window 310 generated by the rotation in the window of the mobile terminal 100, i.e., the second windows as described above. Here, the first icon 311 performs a telephone transmission function as application information corresponding to information displayed on the first window 310, and the second icon 312 performs a message reply function. If the mobile terminal 100 is rotated counterclockwise, the first window 310 of the mobile terminal 100 retrogresses clockwise by the rotational angle of the mobile terminal 100. A second window produced by the clockwise rotation of the first window 310 is different from the second window produced by the counterclockwise rotation of the first window 310. Therefore, additional information different from the first and second icons 311 and 312 is displayed in the portions about the first window produced by allowing the first window 310 to rotate clockwise. As an example of the second windows produced by allowing the first window 310 to rotate clockwise, a delete icon 321 and a storage icon 322 may be displayed in the portions about the first window 310. Here, the delete icon 321 performs a function of deleting a message on the first window 310 as application information capable of performing an edit function for the first window 310, and the storage icon 322 performs a function of storing the message on the first window 310. If the mobile terminal 100 is rotated at 90 degrees, the application described above may be set so that different additional information or applications are displayed according to the rotations in upward and downward directions in the state that the mobile terminal 100 is rotated at 90 degrees. The application described above may be set so that various information or applications are displayed in the portions about the first window 310 differently produced based on the rotational direction or angle.

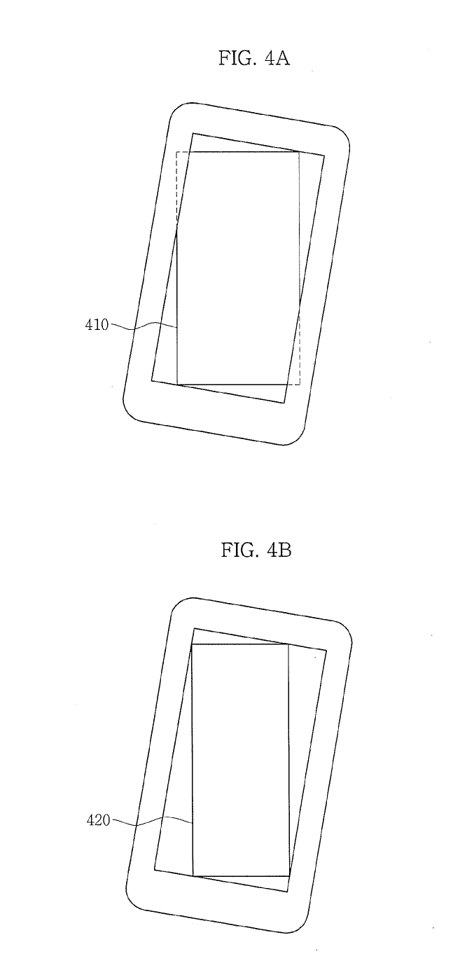

FIGS. 4A and 4B show a window controlled based on the rotation of a mobile terminal according to an exemplary embodiment.

FIG. 4A shows a window rotated having the size of the window maintained. FIG. 4B shows a window rotated having the size of the window reduced.

Referring to FIG. 4A, a first window 410 is rotated according to the rotation of the mobile terminal. In this case, the first window 410 is rotated and the size of the first window 410 is maintained as the original size. A portion of the first window 410 that extends beyond the display panel of the mobile terminal is omitted. Referring to FIG. 4B, a first window 420 is rotated. In this case, the first window 420 is rotated and the size of the second window 420 is reduced. The size of the first window 420 may be reduced at a constant rate. Through the process of reducing the size of the first window 420, the entire first window 420 can be displayed on the display panel of the mobile terminal. The reduction rate may be varied depending on settings, and the reduction rate of as shown in FIG. 4B may be a rate that maintains the size of the first window 420 closest to the original size so that the entire first window 420 is displayed in the display panel of the mobile terminal, i.e., the corners of the first window 420 rotate and follow the edges of the display panel.

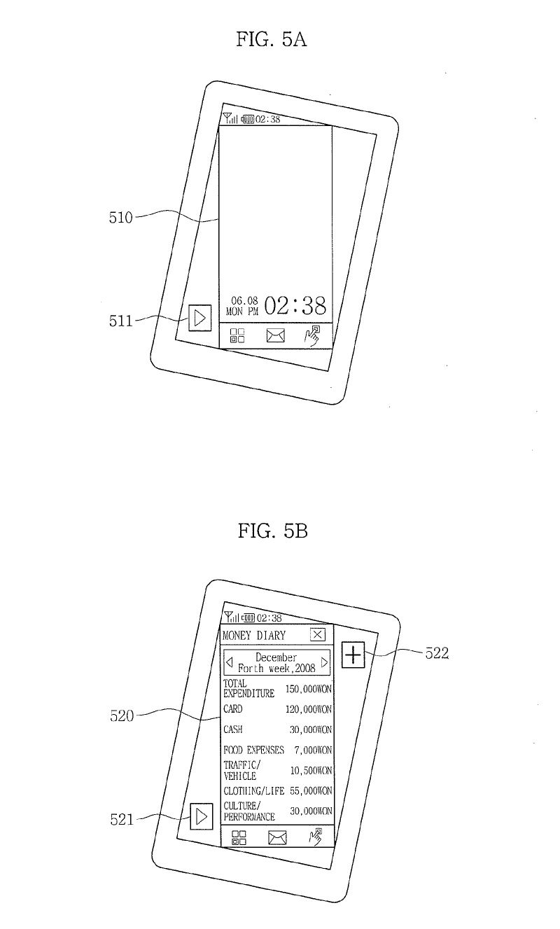

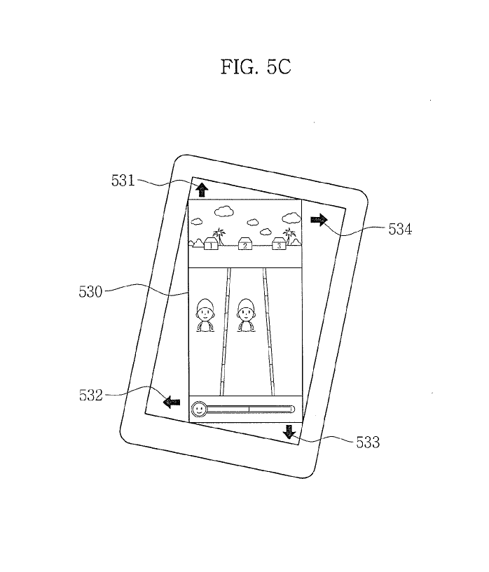

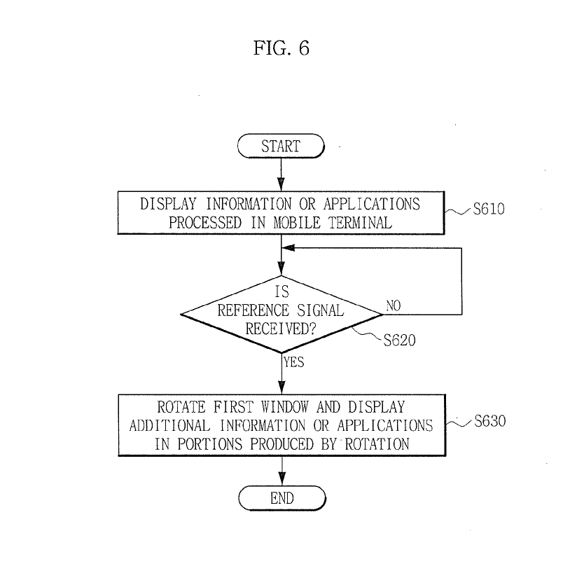

FIGS. 5A, 5B, and 5C show additional information displayed in the portions about the rotated window on a display panel in a mobile terminal according to exemplary embodiments.

FIG. 5A shows a reception standby window rotated on the display panel in the mobile terminal. FIG. 5B shows a window for an application rotated on the display panel in the mobile terminal. FIG. 5C shows a window for an application rotated in the mobile terminal.

Referring to FIG. 5A, an application icon 511 for a basic menu is displayed in at least one of the portions about a rotated window produced by allowing the rotated window, here, a reception standby screen 510 of the mobile terminal, to be rotated counterclockwise. Referring to FIG. 5B, an application icon 521 for the basic menu and an additional application icon 522 related to the “money diary” application are displayed in the portions about the rotated window produced by allowing a window for the “money diary” application, which is one of the applications of the mobile terminal, to be rotated counterclockwise. Referring to FIG. 5C, additional application icons 531, 532, 533, and 534 related to a multimedia application are displayed in the portions about the rotated window produced by allowing a window 530 for the multimedia application to be rotated counterclockwise. The information or applications displayed in the portions about the rotated window may include detailed information related to the information displayed in the rotated window in addition to application information related to the basic menu information or information unrelated to the information displayed in the rotated window. The information or applications may be variously implemented according to aspects of the invention.

FIG. 6 is a flowchart illustrating a method for displaying information using the mobile terminal of FIG. 1. Referring to FIG. 6, information processed in the mobile terminal is displayed (S610). If a reference signal is inputted to or received in the mobile terminal (S620), a current window displayed in the mobile terminal is stored (S630), and additional information is further displayed on a blank screen except the current window, produced by rotating the stored current window (S640).

In FIG. 6, information processed in the mobile terminal is displayed (S610). If a reference signal is inputted to or received in the mobile terminal (S620), the displayed screen is rotated, and additional information or applications are displayed in the portions about the rotated window produced by the rotation (S630).

The operation (S620) of inputting or receiving the reference signal may include the operations of rotating the mobile terminal; generating a motion detection signal based on the rotation of the mobile terminal; and recognizing the motion detection signal as the reference signal. In the operation of displaying the additional information or applications (S630), the displayed screen is rotated in the opposite direction to the rotational direction of the mobile terminal, and additional information or applications are displayed in the portions about the rotated window produced by the rotation.

The operation (S630) of displaying the additional information or applications may include the operations of reducing a size of the rotated window at a predetermined rate; and rotating the reduced window and displaying additional information in the portions about the rotated window produced by the rotation. Further, the operation (S630) of displaying the additional information or applications may include omitting portions of the rotated window.

The mobile terminal and the method for displaying information using the same, described above, are not limited to the configurations and methods of the aforementioned exemplary embodiments, and may be configured by selectively combining the whole or some of the respective exemplary embodiments.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A mobile terminal, comprising:
a display unit comprising a display panel to display first information processed in the mobile terminal; and
a control unit to control the first information displayed on the display unit, and, if a reference signal is received to the mobile terminal, to rotate a first window of the first information to an angle with respect to the display panel and to display second information in at least a first portion of the display panel between an edge of the first window and an edge of the display panel, the first portion being produced by a rotation of the first window.

2. The mobile terminal according to claim 1, further comprising:
a sensing unit to sense a rotation of the mobile terminal and to generate a motion detection signal, the motion detection signal being the reference signal,
wherein the control unit rotates the first window of the first information displayed on the display panel in an opposite direction to a rotational direction of the rotation of the mobile terminal.

3. The mobile terminal according to claim 1, wherein:
the display unit comprises a touch panel; and
the control unit rotates the first information and displays the second information based on a touch or a drag on the touch panel, the reference signal being generated in response to the touch or the drag.

4. The mobile terminal according to claim 1, wherein the control unit controls different second information to be displayed in a second portion of the display panel between an edge of the first window and an edge of the display panel, the second portion being produced by the rotation of the first window and being different from the first portion.

5. The mobile terminal according to claim 4, wherein the different second information displayed in the second portion of the display panel is different according to a rotation angle of the mobile terminal.

6. The mobile terminal according to claim 4, wherein the different second information displayed in the second portion of the display panel is different according to a rotation direction of the mobile terminal.

7. The mobile terminal according to claim 1, wherein the control unit reduces a size of the first window of the first information at a predetermined rate.

8. The mobile terminal according to claim 1, wherein the control unit reduces a size of the first window of the first information to display the entire first window on the display panel.

9. The mobile terminal according to claim 1, wherein the control unit reduces a size of the first window of the first information such that corners of the first window follow edges of the display panel while the first window is rotated.

10. The mobile terminal according to claim 1, wherein the second information comprises one or more of basic menu application information, application information corresponding to the first window, and detailed information of the first window.

11. A method for displaying information using a mobile terminal, the method comprising:
displaying information processed in the mobile terminal on a display panel of the mobile terminal;
receiving a reference signal to the mobile terminal; and
rotating the displayed information to an angle and displaying additional information in a first portion of the display panel produced by the rotation if the reference signal is received to the mobile terminal.

12. The method according to claim 11, wherein the receiving of the reference signal comprises:
rotating the mobile terminal;
generating a motion detection signal based on the rotation of the mobile terminal; and
recognizing the motion detection signal as the reference signal,
wherein the displaying of the additional information comprises rotating the displayed information in an opposite direction to the rotational direction of the mobile terminal and displaying the additional information in the first portion produced by the rotation.

13. The method according to claim 11, wherein the displaying of the additional information comprises:
reducing a size of the displayed information; and
rotating the reduced displayed information at a predetermined angle and displaying the additional information in the first portion produced by the rotation.

14. The method according to claim 11, wherein the receiving of the reference signal comprises:
receiving a touch or a drag on a touch panel of the mobile terminal.

15. The method according to claim 11, wherein the displaying of the additional information comprises:
displaying different additional information according to a rotation angle of the mobile terminal.

16. The method according to claim 11, wherein the displaying of the additional information comprises:
displaying different additional information according to a rotation direction of the mobile terminal.

17. The method according to claim 11, wherein the displaying of the additional information comprises:
reducing a size of the displayed information according to a rotation angle of the mobile terminal.

18. The method according to claim 17, wherein the size of the displayed information is reduced to display an entirety of the information.

19. The method according to claim 11, wherein the displaying of the additional information comprises:
omitting a portion of the displayed information according to a rotation angle of the mobile terminal.

20. A method for displaying information using a mobile terminal, the method comprising:
displaying a first window of first information processed in the mobile terminal on a display panel of the mobile terminal;
receiving a reference signal to the mobile terminal; and
rotating the first window at an angle with respect to the display panel and displaying second information in a first portion of the display panel between an edge of the rotated first window and an edge of the display panel produced by the rotation if the reference signal is received to the mobile terminal.
